(19) United States
(12) Patent Application Publication
(10) Pub. No.: US 2021/0214577 A1
(43) Pub. Date: Jul. 15, 2021

(54) ARTICLES OF MANUFACTURE, METHODS, AND PROCESSES FOR REDUCING VOLATILE ORGANIC COMPOUNDS EMISSION USING COATINGS

(71) Applicant: VocLock Technologies, LLC, Boise, ID (US)

(72) Inventors: Warren Boomer, Eagle, ID (US); Jeff Thompson, Boise, ID (US); John Malletta, Boise, ID (US); Michael Eisenman, Boise, ID (US); Evans Baiya, Meridian, ID (US)

(21) Appl. No.: 17/145,953

(22) Filed: Jan. 11, 2021

Related U.S. Application Data
(60) Provisional application No. 62/959,541, filed on Jan. 10, 2020.

(51) Int. Cl. C09D 175/04; C09D 165/02

(52) U.S. Cl. CPC C09D 175/04; C09D 165/02

(57) ABSTRACT

Systems, methods, and a coating for coating a material containing Volatile Organic Compounds (VOC). The coating is generally in the chemical family of polymeric isocyanates and is characterized as a “Mixture,” specifically an Aromatic Isocyanate Pre-polymer. Embodiments of the coating 204 are 100% solids; have a density at 20° C. (68° F.) of 1.3 g/cm3 (10.85 lbs/gal); with a viscosity, dynamic at 20° C. (68° F.) of 2,000 mPas. The formulation contains Polymerics Diphenylmethane Diisocyanate; 4,4′-methylenediphenyl diisocyanate (CAS #101-68-8); Pigment powder; Ultraviolet blockers; Ultraviolet absorbers; and Microbeadlet encapsulated esters.

### CROSS-REFERENCE TO RELATED APPLICATIONS

This application, under 35 U.S.C. § 119, claims the benefit of U.S. Provisional Patent Application Ser. No. 62/959,541 filed on Jan. 10, 2020, and entitled “Method and Processes of Significantly Reducing Volatile Organic Compound Emission Using Novel Coating Approaches,” the contents of which is hereby incorporated by reference herein.

### FIELD OF THE DISCLOSURE

The present disclosure relates generally to coatings to reduce outgassing of volatile organic compounds. More specifically this disclosure relates to isocyanate-based coatings on natural or synthetic rubber such as mulch, infill, and tire crumbs which reduces outgassing and exposure of volatile organic compounds to the external environment.

### BACKGROUND

For years, sports fields, playgrounds, municipal parks and even private landscapes have utilized infill from tire crumbs. There has been an increase in the number of inquiries relative to possible adverse health effects surrounding exposure to tire crumb infill not only in the US and in Canada, but also in Norway, Sweden, France, Taiwan and Korea.

While what is conventionally called “rubber” includes some natural rubber (called latex) from rubber trees, it also contains phthalates (e.g., chemicals that can affect hormones), polycyclic aromatic hydrocarbons (PAHs), volatile organic compounds (VOCs), and other chemicals known or suspected to cause adverse health effects. PAHs, for example, are natural or human-made chemicals that are made when oil, gas, coal or garbage is burned. According to the EPA, breathing air contaminated with PAHs may increase a person's chance of developing cancer, and the Agency for Toxic Substances and Disease Registry (ATSDR) states that PAHs may increase the risk for cancer and also increase the chances of birth defects.

These same chemistries are present in recycled tires, tire crumbs, and other infill material. It is clear that recycled tire crumbs are not chemically inert, rather they break down readily, nor is a high temperature or complex solvent extraction process necessary for the release of toxic metals, VOCs, or even semi-volatile compounds. Typically, VOC are organic compounds, any compound of carbon, whose composition makes it possible for them to react photochemically resulting in evaporation under normal atmospheric conditions of temperature and pressure. Since VOCs are essential ingredients to many products and materials used, they tend to be everywhere in both indoor and outdoor environments.

Studies have shown that tire crumbs now being shred and spread around indoor and outdoor areas are filled with toxic chemicals which are continually releasing VOCs and it occurs at ambient temperature. The rate of outgassing increases with higher temperature and high humidity.

The “outgassing” from the VOCs is typically higher during the day but continues at lower levels at night. Likewise, artificial turf fields that contain VOCs have millions of fragments and have a very high surface area that produces much more outgassing than a flat carpet does.

One concern is whether exposure to tire crumb contaminants causes the same adverse health issues experienced by workers in the rubber tire industry. Occupational studies in this domain document a wide array of health effects, including skin, eye, and respiratory irritation, to three forms of cancer (lung, skin, bladder and laryngeal).

In 2007, the non-profit EHHI commissioned Connecticut Agricultural Experiment Station (CAES) and its Department of Analytical Chemistry to analyze the crumb rubber infill on a synthetic turf field. The results of their findings, the experimental details, are provided in the Tables I-III below.

Table I shows the main organic compounds volatilizing from crumb rubber:

TABLE I

| | | RETENTION | |
|---|---|---|---|
| NAME | CAS NUMBER | TIME (min) | STRUCTURE |
| Benzothiazole | 95-16-9 | 25.2 | 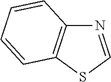 |
| Butylated hydroxyanisole | 25013-16-5 | 32.7 | 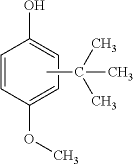 |
| n-hexadecane | 544-76-3 | 35.2 | 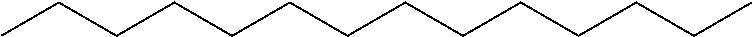 |
| 4-(t-octyl) phenol | 140-66-9 | 35.3 | 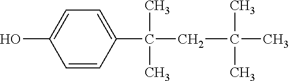 |

Table II shows vapor phase concentrations of compounds outgassed from crumb rubber:

TABLE II

| | | ng/(mL air) normalized |
|---|---|---|
| Compound | ng/mL air | per gram of tire |
| Benzothiazole | 225.87 | 866.72 |
| Hexadecane | 1.58 | 6.04 |
| 4-(tert-Octyl)-phenol | 5.64 | 21.63 |
| Butylated hyroxyanisole | 13.89 | 53.32 |
| or BHT alteration product | | |

Benzene-based chemistries as well as butylated hydroxyanisole, and carbon black are known or suspected carcinogens. Other chemicals that have been found in a sample of ground-up tires include phthalates, latex, zinc, selenium, lead, and cadmium. These are known to leach into water.

Table III shows elements leached into water from crumb rubber:

TABLE III

| | Amount in water | Amount in acidified water |
|---|---|---|
| Element | (μg/kg tire) | (μg/kg tire) |
| Zinc | 20957 | 55010 |
| Selenium | 246 | 260 |
| Lead | 1.85 | 3.26 |
| Cadmium | 0.07 | 0.26 |

Other drawbacks, inefficiencies, problems, and issues with current systems and methods also exist.

### SUMMARY

Accordingly, the herein disclosed articles of manufacture, coatings, and methods and processes of producing and applying the same, address the above-noted, and other, issues, drawbacks, and problems of existing products and methods. Disclosed embodiments include coatings having an aromatic isocyanate pre-polymer mixture. In some embodiments the mixter may include polymerics diphenylmethane diisocyanate, 4, 4′-methylenediphenyl diisocyanate, ultraviolet blockers, ultraviolet absorbers, and microbeadlet encapsulated esters. In some embodiments the coatings can include pigment powders.

In some embodiments, the coatings are substantially 100% solids that have a density at 20° C. (68° F.) of 1.3 g/cm3 (10.85 lbs/gal). In some embodiments the coatings have a viscosity, dynamic at 20° C. (68° F.) of 2,000 mPas.

Also disclosed are systems to reduce photochemical reactions of organic materials, the system includes an organic material containing VOCs that is covered by a first layer having an aromatic isocyanate pre-polymer mixture and a second layer, applied over at least a portion of the first layer, the second coating including the aromatic isocyanate pre-polymer mixture and a catalyst.

In some embodiments the catalyst can include ethylhexanoic, 2-potassium salt. In some embodiments, the catalyst can include 2, 2-dimorpholinodiethlyether. In some embodiments the catalyst can include 2, 2′-oxybisethanol. In some embodiments the catalyst can include organic solvents.

In some embodiments, the aromatic isocyanate pre-polymer mixture locks-in VOC from reaching the surface of the organic material by chemically bonding with the organic material.

Also disclosed are methods for coating materials comprising VOCs. Disclosed methods include mixing a substrate containing VOCs and a coating. Disclosed embodiments of the method may also include adding a catalyst and mixing again and curing and drying the coated substrate.

Other embodiments, advantages, and features also exist.

### BRIEF DESCRIPTION OF THE DRAWINGS

FIG. 1 is a schematic illustration of multi-layered organic material encapsulated to reduce VOC emissions in accordance with disclosed embodiments.

FIG. 2 is a schematic flowchart illustrating methods of application of a coating on a substrate in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

Disclosed embodiments include a chemical coating that helps reduce outgassing (vapor effluents), liquid leaching and micro-particulates from being released from the surface of the rubber under normal atmospheric conditions.

For embodiments intended to meet the above-described environmental conditions, the coating can be thick or nanometer thin, have high elongation, be hard and abrasion resistant, impervious to water ingress (WVTR), resistant to high and low temperatures, resistant to chemicals, resistant to heat, UV passivating, prevent gas permeation, and be unaffected by acids and organic solvents, among others. The herein disclosed embodiments meet these, and other, requirements.

The herein disclosed embodiments are effective because of, among other things, the change of the microstructure change that happen during the coating process at the surface of the candidate substance. The effectiveness of the herein disclosed embodiments is also a combination of the way the microstructural changes are accomplished at the surface as well as the composition of the microstructure itself as evidenced by microstructural analysis using surface and structural materials analysis.

Surface analysis includes particle analysis and identification, such as the elemental analysis of solid samples, detection of impurities and identification of physical and chemical defects. Surface sensitive analyses also include thin film analysis, depth profiling, penetration studies, and purity studies. It also provides analytical expertise to support chemical coating development, forensics, troubleshooting, quality control and failure analysis. Precision analytical technologies are required to assess product quality and to determine the escape of trace level impurities which may present a risk to human health or the environment.

The herein disclosed embodiments have demonstrated reduction of VOC emission in outdoor environments by over 90% which is typically much more effective compared to other conventional methods of reducing/containing VOCs in outdoor environments.

The herein disclosed embodiments also enable the production of a large amount of color rubber mulch of excellent quality that can be used for various purposes both indoors and outdoors.

Chemical, physical and mechanical, and toxicological tests were extensively carried out to confirm both the efficacy and also to ensure that the coating/polymer complies with global and industrial exacting specifications.

VOC tests and analysis included VOC Evaporative Emission testing, identification of VOC's, identification and quantification of residual solvents, odor analysis, and identification of trace off-gas products using chromatography and/or thermal desorption. In addition to the VOCs themselves, the tests included non-volatile content, aqueous mixtures, non-aqueous mixtures, content of VOCs, solids content, specific gravity, and trace analysis.

Surface and structural materials analysis includes microstructural characterization of materials, including polymers, films, coatings, metals, plastics and contaminants. Surface analysis includes particle analysis and identification, such as the elemental analysis of solid samples, detection of impurities and identification of physical and chemical defects. Surface sensitive analyses also include thin film analysis, depth profiling, penetration studies, and purity studies.

The herein disclosed embodiments have tested with various kinds of rubber mulch (mulch-like chip, crumb, flour and/or flake-shaped rubber particles), with different surface areas. In all cases, the herein disclosed embodiments showed low temperature stability (even −60° C.); thermal stability even at above normal temperatures, water resistance, no outgassing detected (comparing weight loss compared to existing alternatives), no aging (due to its elastomeric characteristics), no ultraviolet/weather/color fade detected, no chemical absorption under normal use, and no observable effects from prolonged ozone exposure.

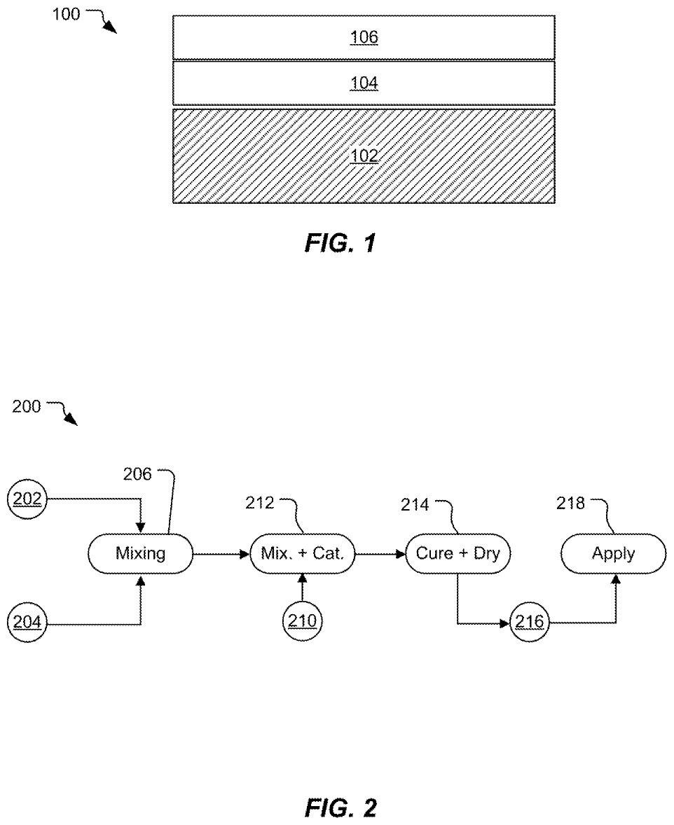

FIG. 1 is a schematic illustration of a system 100 for a multi-layered organic material that has been encapsulated to reduce VOC emissions in accordance with disclosed embodiments. As shown, layer 102 is the organic layer, such as shredded tires and synthetic rubber. Layer 104 is a transition layer (e.g., layer 1) which has been chem-mechanically applied to insulate the organic layer 102 from direct contact with natural elements which could lead to photochemical degradation. Layer 106 (e.g., layer 2) is a coating that encapsulates the transition layer 104 locking any potential gasses that could have been produced from the organic layer 102 that could be in the transition layer 104 from being emitted into the atmosphere. This coating layer 106 is mechanically applied on top of the transition layer 104. The thickness of this coating layer 106 varies from several nanometers to micrometers depending on the thickness of the transition layer 104.

FIG. 2 is a schematic flowchart illustrating methods 200 of application of a coating on a substrate in accordance with disclosed embodiments. As shown, at 202 the substrate to be coated, such as rubber mulch, or other organic material, and the coating 204 are mixed together at 206. In some embodiments, the coating 204 may be colored or otherwise pigmented to result in a colored coating (e.g., water blue, grass green, oxide red, nut brown, and the like). In some embodiments, mixing at 206 may take place in a controlled mixing environment, such as a sealable mixing tank or the like, and is carried out until the desired coverage and consistency is achieved.

Once a desired consistency is achieved, a curing/drying agent or catalyst 210 may be added to the mixture of the substrate 202 and coating 204 as indicated at 212. Additional mixing of the substrate 202, coating 204, and catalyst 210 may also occur at 212 to ensure appropriate mixing is achieved.

As indicated at 214 the coated material is then cured and dried. Additional heating is not required for drying; however, some embodiments may employ additional heating, air-circulation, or the like to facilitate curing and drying.

As indicated at 216 post-drying procedures, such as packaging, labeling, and the like, may be implemented. At 218 the coated material (and, if desired, colored) may then be applied in the desired manner (e.g., used a mulch, as a sports field covering, or the like).

Embodiments of the coating 204 are described as follows. The chemical composition of coating 204 is generally in the chemical family of polymeric isocyanates and labeled according to the Globally Harmonized System (GHS). The coating 204 chemical characterization is as a “Mixture,” specifically an Aromatic Isocyanate Pre-polymer. Embodiments of the coating 204 are 100% solids; have a density at 20° C. (68° F.) of 1.3 g/cm³ (10.85 lbs/gal); with a viscosity, dynamic at 20° C. (68° F.) of 2,000 mPas. The formulation contains Polymerics Diphenylmethane Diisocyanate; 4,4′-methylenediphenyl diisocyanate (CAS #101-68-8); Pigment powder; Ultraviolet blockers; Ultraviolet absorbers; and Microbeadlet encapsulated esters.

Embodiments of the catalyst 210 are described as follows. As noted above, catalyst 210 is used to complete the deposition cycle 212 and is introduced as a liquid when the mixture of solid pieces/particles (e.g., mulch) is uniformly coated and dry to the touch as indicated at 212. The catalyst 210 formulation is labeled according to the GHS and it is characterized as a “Mixture”. The Formulation contains Ethyhexanoic, 2-Potassium Salt; 2, 2′-Dimorpholinodiethlyether; 2, 2′-Oxybisethanol; and Organic Solvents.

Although various embodiments have been shown and described, the present disclosure is not so limited and will be understood to include all such modifications and variations are would be apparent to one skilled in the art.

What is claimed is:

1. A coating comprising:
an aromatic isocyanate pre-polymer mixture comprising:
polymerics diphenylmethane diisocyanate;
4, 4′-methylenediphenyl diisocyanate;
ultraviolet blockers;
ultraviolet absorbers; and
microbeadlet encapsulated esters.

2. The coating of claim 1 further comprising pigment powder.

3. The coating of claim 1 wherein the coating is substantially 100% solids that have a density at 20° C. (68° F.) of 1.3 g/cm³ (10.85 lbs/gal).

4. The coating of claim 3 wherein the coating has a viscosity, dynamic at 20° C. (68° F.) of 2,000 mPas.

5. A system to reduce photochemical reactions of organic materials, the system comprising:
an organic material containing Volatile Organic Compounds (VOC) that is covered by:
a first layer comprising:
an aromatic isocyanate pre-polymer mixture; and
a second layer, applied over at least a portion of the first layer, the second coating comprising:
the aromatic isocyanate pre-polymer mixture; and
a catalyst.

6. The system of claim 5 wherein the aromatic isocyanate pre-polymer mixture comprises:
polymerics diphenylmethane diisocyanate;
4, 4′-methylenediphenyl diisocyanate;
ultraviolet blockers;
ultraviolet absorbers; and
microbeadlet encapsulated esters.

7. The system of claim 5 wherein the aromatic isocyanate pre-polymer mixture comprises pigment powder.

8. The system of claim 5 wherein the catalyst comprises ethyhexanoic, 2-potassium salt.

9. The system of claim 5 wherein the catalyst comprises 2, 2′-dimorpholinodiethlyether.

10. The system of claim 5 wherein the catalyst comprises 2, 2′-oxybisethanol.

11. The system of claim 5 wherein the catalyst comprises organic solvents.

12. The system of claim 5 wherein the aromatic isocyanate pre-polymer mixture locks-in VOC from reaching the surface of the organic material by chemically bonding with the organic material.

13. A method for coating materials comprising Volatile Organic Compounds (VOC) the method comprising:
mixing a substrate containing Volatile Organic Compounds (VOC) and a coating;
adding a catalyst and mixing again; and
curing and drying the coated substrate.

14. The method of claim 13 wherein the coating comprises:
polymerics diphenylmethane diisocyanate;
4, 4′-methylenediphenyl diisocyanate;
ultraviolet blockers;
ultraviolet absorbers; and
microbeadlet encapsulated esters.

15. The method of claim 13 wherein the coating comprises pigment powders.

16. The method of claim 13 wherein the catalyst comprises ethyhexanoic, 2-potassium salt.

17. The method of claim 13 wherein the catalyst comprises 2, 2′-dimorpholinodiethlyether.

18. The method of claim 13 wherein the catalyst comprises 2, 2′-oxybisethanol.

19. The method of claim 13 wherein the catalyst comprises organic solvents.
